(19) United States
(12) Patent Application Publication
(10) Pub. No.: US 2011/0145692 A1
(43) Pub. Date: Jun. 16, 2011

(54) Method for Tracking Annotations with Associated Actions

(76) Inventors: Peter Noyes, Pasadena, CA (US); Benjamin Gunderson, Simi Valley, CA (US)

(21) Appl. No.: 12/639,916

(22) Filed: Dec. 16, 2009

(51) Int. Cl. G06F 3/048; G06F 3/14

(52) U.S. Cl. 715/230; 715/781

(57) ABSTRACT

A method for tracking annotations on a document is contemplated. A first annotation defined by a plurality of first annotation attributes is received. Thereafter, a primary visual representation of the first annotation is generated according to the first annotation attributes. The method continues with associating an action identifier with the first annotation as an action link. A thumbnail representation of the first annotation is generated in a toolbox window. A second annotation defined by a plurality of second annotation attributes and associated with the action identifier derived from the action link for the first annotation is linkable to the document in response to a selection input of the thumbnail representation of the first annotation.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure generally relates to the management of annotations linked to electronic documents, and more particularly, to a method for tracking annotations with associated actions.

2. Related Art

Advancements in high-speed data communications and computing capabilities have increased the use of remote collaboration for conducting business. While real-time collaboration using videoconferencing and the like are gaining popularity, the vast majority of collaboration occurs over e-mail in the exchange of documents incorporating incremental modifications, comments, and the like. A local user may create an initial version of a document, and transmit the same to remotely located colleagues. These remote users may then make their own changes or add comments in the form of annotations appended to the document, and then transmit the new version back to the local user.

Such collaboration may involve the exchange of documents generated with word processing applications, desktop publishing applications, illustration/graphical image manipulation applications, Computer Aided Design (CAD) applications, and so forth. As utilized herein, the term “document” may refer to data produced by any of the aforementioned software applications. Furthermore, the term “content” may refer to data particular to the software application that generated it and stored in the document of the same. Due to the existence of many different computing platforms having a wide variety of operating systems, application programs, and processing and graphic display capabilities, it has been recognized by those in the art that a device-independent, resolution-independent file format was necessary to facilitate such exchange. In response to this need, the Portable Document Format (PDF), amongst other competing formats, has been developed.

The PDF standard is a combination of a number of technologies, including a simplified PostScript interpreter subsystem, a font embedding subsystem, and a storage subsystem. As those in the art will recognize, PostScript is a page description language for generating the layout and the graphics of a document. Further, per the requirements of the PDF storage subsystem, all elements of the document, including text, vector graphics, and raster (bitmap) graphics, collectively referred to herein as graphic elements, are encapsulated into a single file. The graphic elements are not encoded to a specific operating system, software application, or hardware, but are designed to be rendered in the same manner regardless of the specificities relating to the system writing or reading such data. The cross-platform capability of PDF aided in its widespread adoption, and is now a de facto document exchange standard. PDF has been released as an open standard published by the International Organization for Standardization (ISO) as ISO/IEC 3200-1:2008. Currently, PDF is utilized to encode a wide variety of document types, including those composed largely of text, and those composed largely of vector and raster graphics. Due to its versatility and universality, files in the PDF format are often preferred over more particularized file formats of specific applications. As such, documents are frequently converted to the PDF format.

A number of useful improvements have been made since the initial releases of PDF readers, writers, and the standard itself. One improvement that is particularly beneficial in a collaborative environment is the support for adding annotations to a base document. For example, a local user creates an initial version of a document, and transmits the same to distant colleagues. Thereafter, these remote users add their comments as annotations, and transmit the newly annotated versions of the document back to the local user for further revisions. Such annotation features are useful in a wide variety of collaborative settings, such as between a client and a service provider, within a corporate hierarchy, and so forth. It is noted that PDF is not the only document format incorporating collaboration features, and files generated by word processor, spreadsheet, and presentation applications such as Word, Excel, and PowerPoint, respectively, all from Microsoft Corp. of Redmond, Wash., also include the feature of adding annotations and tracking revisions.

From the user interface perspective, PDF documents are typically rendered as a static, graphical image, in which individual elements thereof such as text, pictures, and other elements are not editable. The aforementioned annotations are graphically overlaid or “placed” on the underlying document, with placement being precisely controlled by the user. Thus, the functionality is similar to graphic illustration/design and image manipulation applications where various objects can be positioned on a document canvas by navigating a cursor to a desired location and providing a subsequent input to make placement permanent. Prior to positioning the cursor, the object to be placed, such as a geometric primitive, a text box, or the like, is selected.

The information/subject matter stored in and exchanged as PDF files is becoming increasingly complex, with a wide range of documents being digitized as part of the trend toward paperless offices. Indeed, engineering diagrams, construction plans, wiring diagrams, and so forth are oftentimes saved in, and shared via, PDF documents. These types of documents often span multiple pages or even multiple documents, with various segments providing additional levels of detail that a broader view cannot provide. For example, construction plans typically comprise floor plans and elevations that show an overhead cross-section and two-dimensional side views of the building, respectively. With paper documents, relating the further detailed views of a particular section of the construction plan involves placing a visual symbol on both views that link the two together. In electronic documents such as PDF files, it would be convenient and advantageous to be able to follow a link to the alternate view, with the intermediate steps of opening, locating, and navigating thereto being performed automatically.

Along these lines, PDF documents are delivering increasing levels of interactivity, incorporating video, audio, three-dimensional models, and other multimedia data. Other sources of data such as the World Wide Web can also be linked to a PDF document. Furthermore, basic system operations can be invoked directly from the PDF file, and other local applications can be called from within to handle different types of external data.

In general, existing modalities for managing these types of interactive items is cumbersome and involves numerous manual steps. Continuing with the above example of linking different views in construction plan documents, for each instance where there is to be a jump to a detailed view, a symbol is placed. Then, a hyperlink tool is used to outline a clickable region therefor, and the detailed view is selected. This process involves frequently switching back and forth between different parts of the document or between different documents altogether, and must be repeated for each detailed view. For drawings that may contain hundreds or even thousands of sheets, particularly where the regions are not perfectly consistent between symbols, it is extremely labor-intensive.

Another possible way for adding the above-described interactivity to documents involves a “Named Destinations” feature defined in the PDF specification and implemented in the Adobe Acrobat version 9 application by Adobe Systems, Inc. of San Jose, Calif. As a minor improvement, it is possible for a hyperlink destination to be named and defined in a central location within the PDF file, such that the hyperlink can be reused. First, a destination is defined by selecting a page of the document or a portion thereof. Then, in a separate process, a segment of the document for an activatable region is defined. After a series of parameter editing screens, the named destination is selected. The Named Destinations feature is unfortunately lacking in a number of respects, including the inability to conveniently generate multiple hyperlinks to a common destination, inability to reference named destinations in another file, and an unintuitive structure that precludes linking a symbol with an action as a single combined entity for reducing management burdens.

In the Named Destinations feature, the hyperlink or activatable region itself is clicked or otherwise selected to invoke the destination associated therewith. In other applications outside the Acrobat/PDF context such as in the word processing, spreadsheet, and presentation applications suite of Office from Microsoft Corporation of Redmond, Wash., a link associated with a symbol on the document can be invoked with a simultaneous keyboard and mouse input, such as CTRL+Click. Without the secondary keyboard input, a window for editing the various attributes of the symbol may be activated upon clicking. The overall user interface experience may be deficient, however, in that the need for the secondary input may not be immediately apparent, particularly with certain input modalities such as digitizers.

Accordingly, there is a need in the art for a streamlined and efficient method for adding further interactivity to annotations. Furthermore, there is a need in the art for those annotations to be individually editable, and to be stored and tracked for subsequent reuse internal or external to the original document. There is also a related need for the interactive functions to be accessible via multiple input modalities. Thus, in general, there is a need for an improved method for tracking annotations with associated actions.

### BRIEF SUMMARY

In accordance with one embodiment set forth in the present disclosure, a method for tracking annotations on a document is contemplated. The method may include receiving a first annotation that is defined by a plurality of first annotation attributes. Furthermore, the method may include generating a primary visual representation of the first annotation according to the first annotation attributes. The first annotation may be overlaid on the document displayed in a workspace window. A step of associating an action identifier with the first annotation as an action link may also be included. The action identifier may have an action function selected by a user and a set of action parameters. The method may further include a step of generating a thumbnail representation of the first annotation in a toolbox window. A second annotation defined by a plurality of second annotation attributes and associated with the action identifier derived from the action link for the first annotation may be linkable to the document in response to a selection input of the thumbnail representation of the first annotation.

According to another embodiment, a method for tracking annotations on a document is contemplated. The method may include a step of linking a first annotation to the document, where the first annotation is defined by a plurality of first annotation attributes. The method may also include associating an action identifier with the first annotation as a first element of an action link. The action identifier may include an action function having a document destination and a set of action parameters. There may also be a step of generating a thumbnail representation of the first annotation in a toolbox window, as well as a step of linking a second annotation to the document in response to a first input. The second annotation may be defined by a plurality of second annotation attributes. The method may also include associating the action identifier with the second annotation as a second element of the action link different from the first element of the action link.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an exemplary computer system that may be capable to perform functions for use with aspects of the present invention including a display monitor;

FIG. 2 is a block diagram of system components of the exemplary computer system of FIG. 1;

FIG. 3 is an exemplary graphical user interface of an application including a workspace window and a toolbox window, in which several embodiments of the present disclosure may be implemented;

FIG. 4 is a block diagram illustrating exemplary attributes associated with an annotation or data object;

FIG. 5 is a flowchart illustrating the steps of a method for tracking annotations with associated actions in accordance with one embodiment;

FIG. 6 is a graphical representation of an example annotation that may be represented by the data structure shown in FIG. 4;

FIG. 7 is a block diagram illustrating the relationship between the annotation and an action identifier;

FIG. 8 is a detailed view of the graphical user interface showing a context-sensitive menu and sub-menu for associating the annotation with the action identifier;

FIG. 9 is an exemplary action definition screen with a jump to page function selected;

FIG. 10 is the exemplary action definition screen with a snapshot view function selected;

FIG. 11 is an example detail page supplementing the more general architectural plan shown in FIG. 3; and

FIG. 12 is an expanded view of the detail page of FIG. 11 showing a selected region;

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one entity from another without necessarily requiring or implying any actual such relationship or order between such entities.

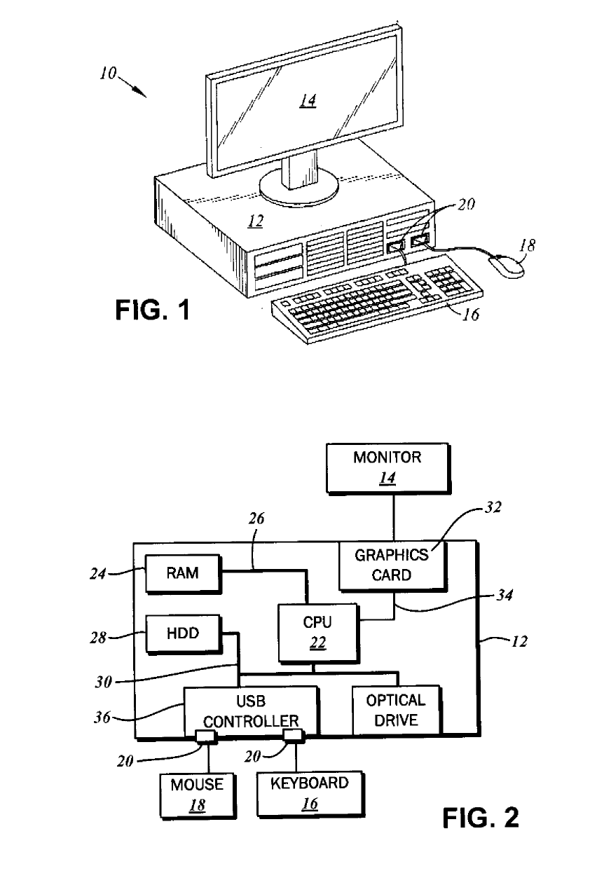

With reference to FIG. 1, an exemplary hardware environment in which aspects of the present invention may be implemented includes a computer system 10 with a system unit 12 and a display monitor 14. The display monitor 14 graphically displays output from the data processing operations performed by the system unit 12. The display monitor 14 is a visual output device and includes some form of screen. The display monitor 14 may be of a Liquid Crystal Display (LCD) type, a Cathode Ray Tube (CRT) type, or any other suitable type of display. Devices such as a keyboard 16 and a mouse 18 provide input to the data processing operations, and are connected to the system unit 12 via USB ports 20. Various other input and output devices may be connected to the system unit 12, and alternative interconnection modalities may be substituted with the USB ports 20.

As shown in the block diagram of FIG. 2, the system unit 12 includes a Central Processing Unit (CPU) 22, which may represent one or more conventional types of such processors, such as an IBM PowerPC, Intel Pentium (x86) processors, and so forth. A Random Access Memory (RAM) 24 temporarily stores results of the data processing operations performed by the CPU 22, and is interconnected thereto typically via a dedicated memory channel 26. The system unit 10 may also include permanent storage devices such as a hard drive 28, which are also in communication with the CPU 22 over an input/output (I/O) bus 30. Other types of storage devices such as tape drives, Compact Disc drives, and the like may also be connected. A graphics card 32 is also connected to the CPU 22 via a video bus 34, and transmits signals representative of display data to the display monitor 14. As indicated above, the keyboard 16 and the mouse 18 are connected to the system unit 12 over the USB port 20. A USB controller 36 translates data and instructions to and from the CPU 22 for external peripherals connected to the USB port 20. Additional devices such as printers, microphones, speakers, and the like may be connected to the system unit 12.

The system unit 12 may utilize any operating system having a graphical user interface (GUI), such as WINDOWS from Microsoft Corporation of Redmond, Wash., MAC OS from Apple, Inc. of Cupertino, Calif., various versions of UNIX with the X-Windows windowing system, and so forth. The system unit 12 executes one or more computer programs, with the results thereof being displayed on the display monitor 14. Generally, the operating system and the computer programs are tangibly embodied in a computer-readable medium, e.g. one or more of the fixed and/or removable data storage devices including the hard drive 28. Both the operating system and the computer programs may be loaded from the aforementioned data storage devices into the RAM 24 for execution by the CPU 22. The computer programs may comprise instructions, which, when read and executed by the CPU 22, cause the same to perform or execute the steps or features of the various embodiments set forth in the present disclosure.

According to one embodiment, a user can interact with the system 10, specifically with the graphics being displayed on the monitor 14, via the mouse 18. The movement of a cursor generated on the monitor 14 is tied to the movement of the mouse 18, with further interactivity being provided with input from the mouse buttons. Input from the keyboard 16 also provides interactivity with the system 10. The following description refers to “clicking” the mouse buttons, “positioning” the cursor, “holding” the mouse button to “drag” an on-screen object, and so forth. It will be appreciated by those having ordinary skill in the art that such terms have well-understood meanings relative to interactions with the system 10 through a graphical user interface. Various embodiments of the present invention can be implemented on tablet form factor computer systems, which utilize pen-based input devices, touch-sensitive input devices, and so forth. The input terminology associated therewith find correspondence to conventional mouse-based graphical user interfaces, for example, clicking an item on the interface may be equivalent to tapping the item on a pen-based system.

The foregoing computer system 10 represents only one exemplary apparatus suitable for implementing aspects of the present invention. As such, the computer system 10 may have many different configurations and architectures. Any such configuration or architecture may be readily substituted.

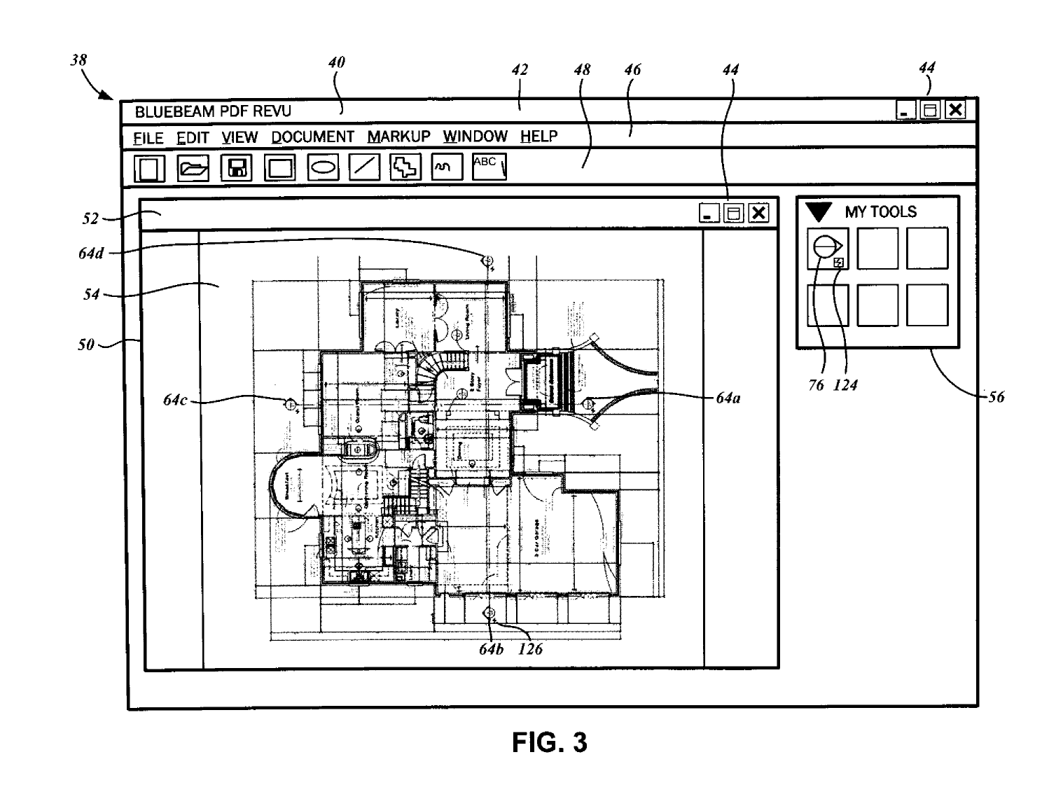

FIG. 3 illustrates one exemplary graphical user interface 38 of a PDF reviewing software application in which various embodiments of the method for tracking annotations with associated actions may be implemented. While various exemplary embodiments set forth below are described in relation to such a PDF reviewing software application, it will be appreciated that any other graphic manipulation software application may instead be substituted. As indicated above, the software application runs on a windowing system, and accordingly has a number of interface elements that are common to applications for the same.

In further detail, the functional, interactive features of the graphical user interface 38 are contained within a main window 40 that includes a title bar 42 with basic window controls 44 that variously minimize, maximize, and close the main window 40. In addition, the main window 40 includes a menu bar 46, from which various functions of the reviewing software application may be invoked via activated pull-down menus. So that commonly utilized functions such as opening files, saving changes to the currently opened file, and so forth are readily accessible, there is also a tool bar 48. As will be described more fully below, it is contemplated that annotations of various types can be placed and manipulated via the graphical user interface 38. Selection of the annotation type may be made with the respective icons of the tool bar 48.

Within the main window 40 is a workspace window 50, which includes a sub-title bar 52 and basic window controls 44. There is a document 54 that is rendered within the workspace window 50. In the example shown, the document 54 is an architectural drawing comprised of various graphical elements including lines, arcs, and text. It will be understood that any other content such as raster images may also be included in the document 54. Although in the exemplary embodiment the document is a PDF file structured in accordance with the standard as discussed above, it is expressly contemplated that any other suitable document format may be rendered in the workspace window 50.

Also within the main window 40, there is a toolbox window 56 that displays an inventory of selected, most often used, or most recently used annotations. Further pertinent aspects of the toolbox window 56 are described in greater detail below. In accordance with various embodiments, the toolbox window 56 is contemplated to have the functionality similar to that set forth in U.S. Pat. No. 7,600,193 to Gunderson entitled “A METHOD OF TRACKING DUAL MODE DATA OBJECTS USING RELATED THUMBNAILS AND TOOL ICONS IN A PALETTE WINDOW,” the disclosure of which is wholly incorporated by reference herein.

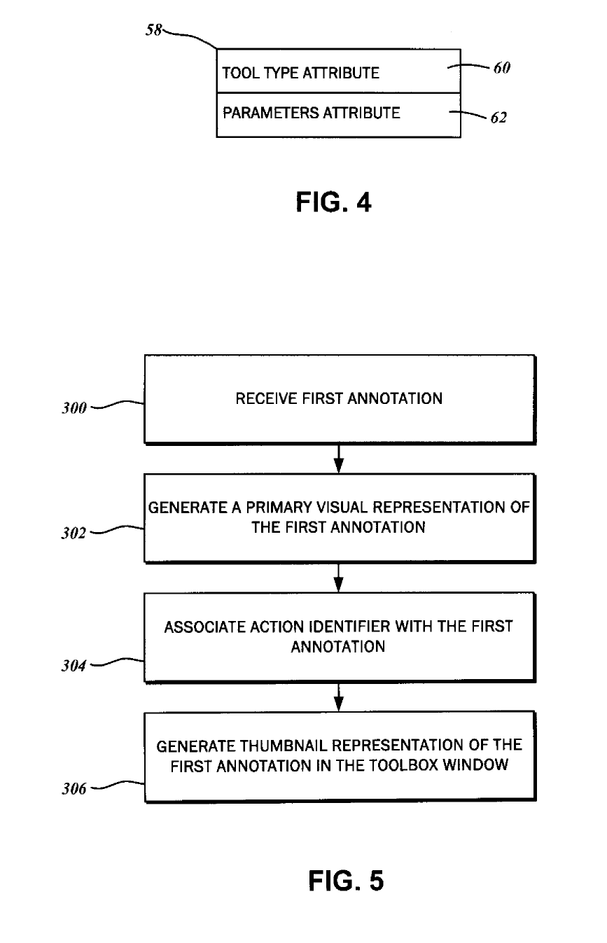

Annotations are understood to be a type of data object that is associated with an underlying document, and generally refers to a conceptual entity corresponding to a contiguous block of memory at a specific location and with a specific size, and is defined by one or more properties that define its characteristics. Referring to FIG. 4, an exemplary data object 58 includes a tool type attribute 60, and a parameters attribute 62. It is understood that an annotation can be a geometric primitive such as a point, a line (single segment or multi-segment), an ellipse, a polygon, or the like, as well as specialized annotation object such as callout boxes. A “tool” therefore refers to such broad categories of objects, and so the tool type attribute associates the annotation as being a specific one of these categories. To further define the features of the annotation, the parameters attribute 62 can include the dimensions, color, line thickness, positioning coordinates, and other parameters that are specific to the tool type.

It is contemplated that multiple annotations or data objects can be combined into one, in which case the tool type attribute may have a value indicative of a group, with different parameter attributes 62 further defining the features of constituent objects. Although these annotations may be created from its basic parts each time prior to use, they may also be predefined and provided as part of a default template. The particular data structure of the annotation is presented by way of example only and not of limitation, and any other suitable data structure to represent the annotation may be substituted.

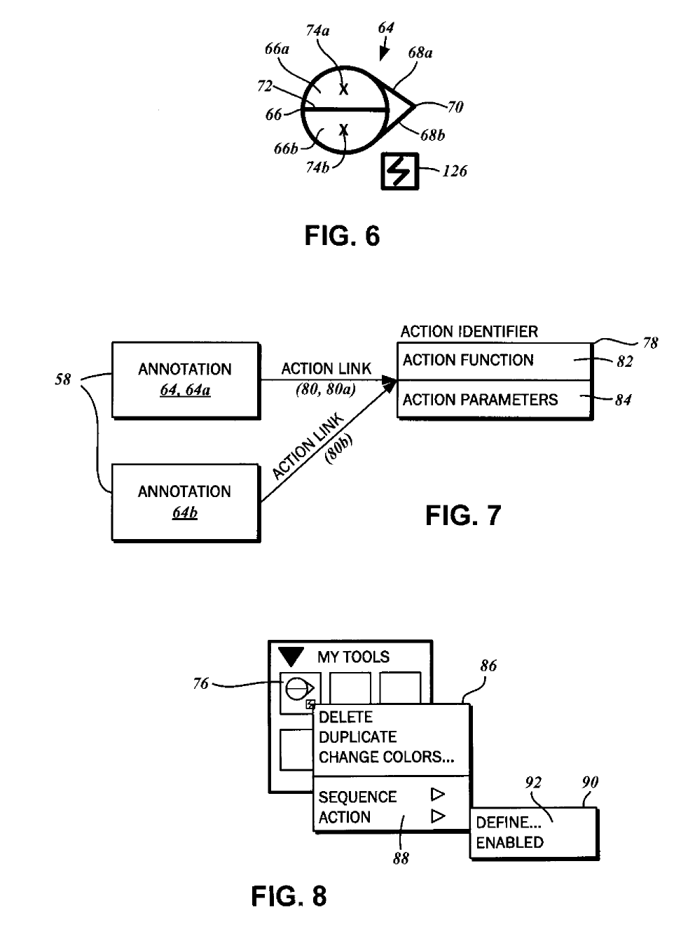

With reference to the flowchart of FIG. 5, a method for tracking annotations on a document begins with a step 300 of receiving a first annotation that is defined by a plurality of first annotation attributes. It is understood that the first annotation attributes refers to the tool type attribute 60 and the parameters attributes 62. FIG. 6 best illustrates one example annotation 64 comprised of a circle 66 and a pair of opposed lines 68 tangent to the circle 66 and meeting at a point 70. There is also a line 72 that bisects the circle 66, with text 74a, 74b inside each respective hemisphere 66a, 66b. Each of these individual elements may be represented as a data object 58, and grouped together into another super-data object. As noted above, each of these constituent parts may be individually positioned on to the workspace window 50 by navigating a cursor to the selected location and providing an input to place that part on the document 54. After placing all of the parts in this manner, a unified grouping thereof may be set, thereby defining the annotation 64. The step 300 of receiving the first annotation may thus refer to the graphical construction of it, and associating it with the document 54.

Along these lines, the step 300 may more generally refer to pasting in the annotation 64 from a clipboard or other storage, and similarly associating it with the document 54. In further detail, the toolbox window 56 includes a thumbnail representation 76 of the annotation 64, and upon selecting it, the function of placing a copy of the corresponding annotation 64 on to the document 54 is activated. The data object representing the annotation 64, that is, the specific tool type attribute 60 and the parameters attributes 62 thereof, is stored in a memory associated with the toolbox window 56 and its functionality. The cursor is navigated to a desired location, and an input is provided to place the annotation 64. A new annotation with the tool type attribute 60 and the parameters attributes 62 from the stored data object is created. It will be appreciated that the foregoing modalities for placing the annotation 64 on the document is presented by way of example only and not of limitation, and any other suitable modality may be readily substituted.

Upon receipt of the annotation 64 per above, the method includes a step 302 of generating its primary visual representation in the workspace window. The above-described process of receiving the first annotation is understood to be independent of the step of displaying it, though the two steps may occur almost simultaneously. As shown in FIG. 3 and described above, the annotation 64 is overlaid on the document 54, and the document 54 is shown as having four annotations 64a-d.

Referring again to the flowchart of FIG. 5, the method then continues with a step 304 of associating an action identifier with first the annotation as an action link. As best illustrated in the diagram of FIG. 7, the annotation 64, that is, the data structure 58 that represents it is logically connected to an action identifier 78 via an action link 80. The action identifier 78 includes a user-selectable action function 82, along with action parameters 84 that serve as input conditions thereto. As will be described in further detail below, the action function 82 is selected by the user, for user intervention typically associates an annotation with an action. It will be appreciated that any suitable data structure for representing the relationship between the aforementioned entities may be substituted with a corresponding modification to the management of the annotations 64 and its related action identifiers 78.

Generally, an action refers to any procedure that is performed upon being invoked by the user, and may enhance the interactivity of the document 54. In accordance with various embodiments of the present disclosure, these actions can be linked to one or more annotations, such that clicking on or otherwise activating an annotation serves to invoke the associated functionality or procedure. The specifics of the procedures that can be initiated are set forth in the action function 82, which have standard definitions under the PDF standard per table 1. Each of the functions is understood to have corresponding action parameters 84 unique thereto.

TABLE 1

| Action Type | Description |
|---|---|
| GoTo | Go to a destination in the current document |
| GoToR | (“Go-to-remote”) Go to a destination in another |
| | document. |
| GoToE | (“Go-to-embedded”) Go to a destination in an embedded |
| | file. |
| Launch | Launch an application, to open a file. |
| Thread | Begin reading an article thread. |
| URI | Resolve a uniform resource identifier. |
| Sound | Play a sound. |
| Movie | Play a movie. |
| Hide | Set a Hidden flag of an annotation. |
| Named | Execute an action predefined by the viewer application. |
| SubmitForm | Send data to a uniform resource locator. |
| ResetForm | Set fields to default values. |
| ImportData | Import field values from a file. |
| JavaScript | Execute a JavaScript script. |
| SetOCGState | Set the states of optional content groups. |
| Rendition | Controls the playing of multimedia content. |
| Trans | Updates the display of a document, using a transition |
| | dictionary. |
| GoTo3DView | Set the current view of a 3D annotation. |

According to one embodiment, the action identifier 78 is associated with the first annotation 64 upon the same being placed in the toolbox window 56 as a reusable annotation as depicted by the thumbnail representation 76. Therefore, it is contemplated that a step 306 of generating the thumbnail representation 76 of the first annotation 64 may occur prior to the step 304 in these embodiments. Alternative embodiments are contemplated, however, where an action identifier 78 is associated with the annotation 64 by modifications thereto made via the workspace window 50. In such a case, the step 304 occurs before step 306. It is thus expressly envisioned that the order in which the various steps are performed is inconsequential.

FIG. 8 illustrates the embodiment where the first annotation 64 is already part of the toolbox window 56 as described above. Here, the thumbnail representation 76 is right-clicked to load a context-sensitive menu 86, and a menu element 88, captioned “Action” is then selected therefrom. This selection, in turn, loads a context-sensitive sub-menu 90, and in order to associate annotations placed by selecting the thumbnail representation 76 to the action identifier 78, a menu element 92, captioned “Defined . . . ” is selected.

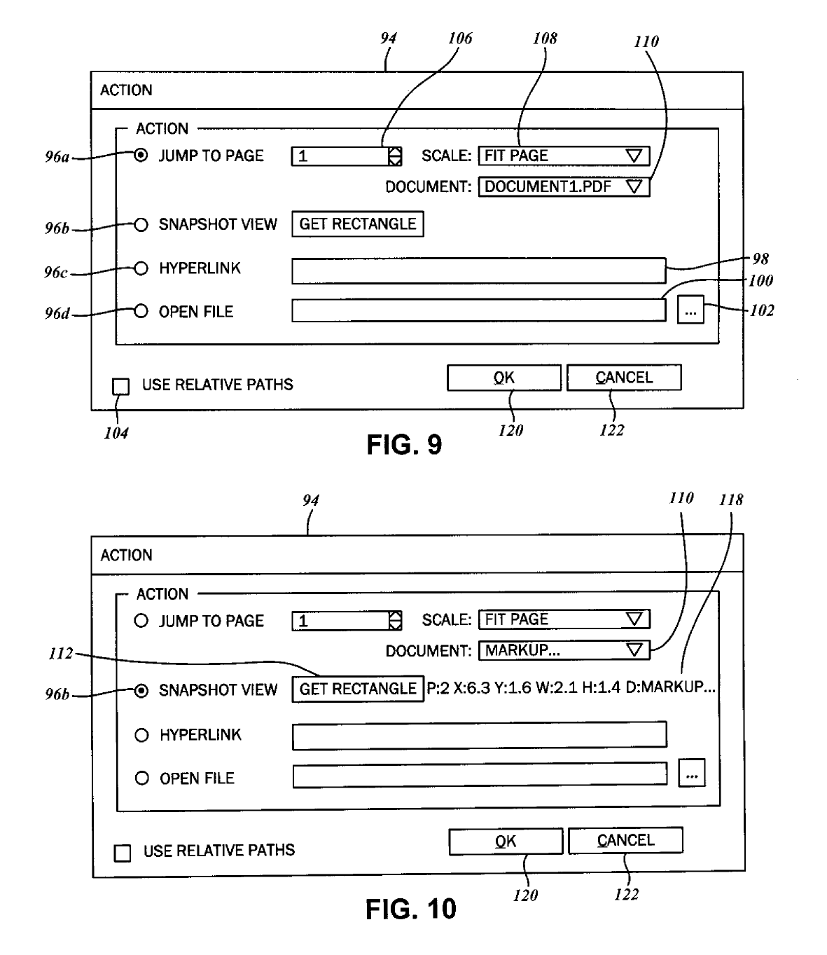

With reference to FIG. 9, the previous selection of the menu element 92 invokes an action edit window 94. As noted above, it is possible to select one of several action functions 82 to be associated with an annotation. In the illustrated embodiment, the action functions of jumping to a specific page, jumping to a specific view, opening a hyperlink, and opening a file can be selected by activating one of radio buttons 96a-96d.

Among these, the opening of the hyperlink and the opening of the file are the simplest, so an initial brief mention will be made. In an input box 98, a Uniform Resource Identifier (URI) may be entered after selecting the radio button 96c. It will be recognized that the resource identified thereby will be retrieved and displayed in the relevant viewer; if the referenced document is another PDF file, then it will be rendered by the PDF viewer, or if the referenced document is a text-based HTML file, then it will be rendered by the Web browser application, etc. Along these lines, a local file may be specified via an input box 100. The directory path and the filename may be typed into the input box 100, but in the alternative, a standard file browser may be invoked via a browser icon 102. The URI, as well as the file path, are understood to be a part of the set of action parameters 84. The location of the file may be specified in absolute terms, that is, the volume identifier and each directory to the root level is specified. The location of the file may also be specified in relative terms, which omit such details. Absolute paths may be useful when the document 54 and those related thereto will remain at a central location, whereas relative paths may be useful where the group of documents is transferred frequently from one location to another. Absolute or relative paths may be selected via a checkbox 104. It is understood that this selection will also be applicable to specifying the path for the document jump point function, which will be described in greater detail below.

As briefly noted above, one of the contemplated action functions 82 is changing the view on the workspace window 50 to that of a specified page location, i.e., jumping to a particular page on the document 54. The radio button 96a is selected, and various options that are part of the set of action parameters 84 are selected. First, the page to which the view is changed is specified in a spinner box 106, and the scale at which that page of the document 54 is to be rendered is specified in a pull-down menu 108. Different pre-set scaling levels are enumerated in the pull-down menu 108. Additionally, the selected page may be part of the currently loaded document 54, or of a different document. The selection of the document is possible via a pull-down menu 110. In one contemplated embodiment, a listing of all of the documents currently open within the application may be enumerated in the pull-down menu 110.

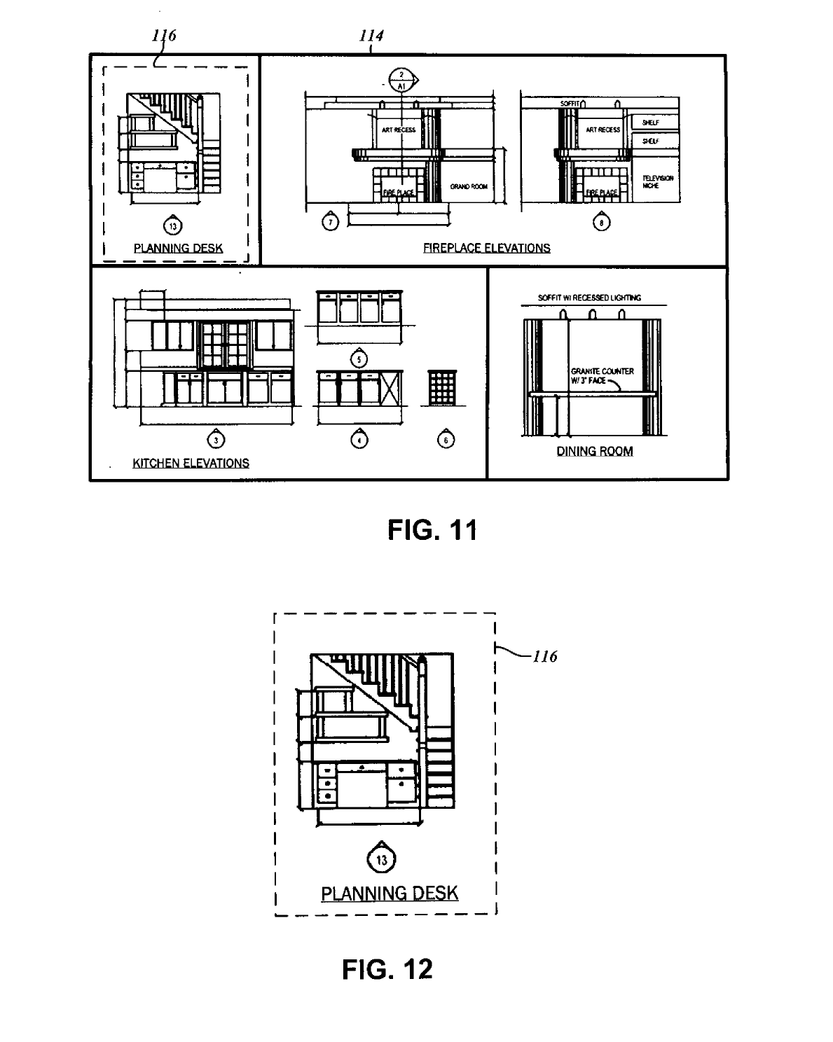

Another one of the contemplated action functions 82 is changing the view on the workspace window 50 to that of a selected region or snapshot of a document. In this case, as shown in FIG. 10, the radio button 96b is selected. A region capture button 112 is clicked, which may be operative to minimize the action edit window 94. FIG. 11 shows an exemplary detail page 114 that supplements the general architectural plan shown in FIG. 3, and a region 116 is selected therefrom. The detail page 114 may be part of the same document 54, or a different document. Selecting this action from the corresponding annotation is operative to expand the view of the workspace window 50 to the selected region 116, as shown in FIG. 12. Upon selecting the region 116, a portion of the action edit window 94 is updated with region detail data 118, including X and Y coordinates, dimension, and document name, which are understood to be a part of the set of action parameters 84. The pull-down menu 110 is also updated with the selected document name.

It will be appreciated by those having ordinary skill in the art that although specific user interface elements are utilized in the action edit window 94, any other suitable or appropriate element may be substituted. The specific configuration of the action edit window 94 is presented by way of example only and not of limitation.

Depending on the set of action parameters 84 provided, the action function 82 may have a destination that is independent of the current document 54, or may be specific to the current document 54. Both the jump to page function and the jump to snapshot function detailed above can refer to a location on the currently active document or a location outside the currently active document. When specifying a URI or an external file, the reference is understood to be independent of the currently active document. Besides functions that are destination-oriented, others such as printing the document, clearing form fields, and the like are also contemplated. The broad characterization of the action function according to these delineations affect the way in which the annotations and associated action identifiers are retained and reused, as will be described more fully below.

Referring again to the action edit window 94 of FIGS. 9 and 10, once the desired function is selected via the radio buttons 96 and the parameters are set, an OK button 120 can be clicked to commit the action link 80. Alternatively, a cancel button 122 may be selected to close the action edit window 94 without associating any annotation to an action identifier. Thereafter, as best shown in FIG. 3, the thumbnail representation 76 includes a visual cue 124 that indicates there is an action identifier associated with its corresponding annotation.

From a selection of the thumbnail representation 76, a second annotation also defined by a set of attributes including the tool type attribute 60 and the parameter attributes 62 is linkable to the document 54. With further reference to the block diagram of FIG. 7, the new annotation 64b is also understood to include a reference to the same action identifier 78 of the parent annotation 64a, as an action link 80b. In this regard, the linking element of the first annotation 64a and the second annotation 64b are both generally referred to as the action link 80, but may be specifically referenced as a first element 80a and a second element 80b, respectively. The action links 80 may be stored within the PDF file. The tool type attribute 60 and the parameter attributes 62 of the second annotation 64b are contemplated as having been derived at least in part from the tool type attribute 60 and the parameter attributes 62 of the first annotation 64a, such that the appearances of the two annotations are substantially similar. As explained above, this interface permits and encourages the re-use of annotations, particularly those that have associated actions.

With reference to FIG. 6, upon placement of the second annotation 64b on the document 54, an indicator 126 is generated in close proximity. It is also understood that upon associating an action with any annotation 64, the indicator 126 is appended thereto. By clicking or otherwise selecting the indicator 126, the action function associated with the corresponding annotation 64 is triggered with the preset action parameters 84, as discussed above. It is envisioned that this separate, activatable indicator is particularly beneficial in pen input systems such as Tablet PCs because of the combined functional and spatial segregation between editing the annotation 64 and invoking its associated action. Along these lines, because the annotation 64 is logically linked to the action, edits and placement modifications of the annotation 64 do not affect the action. As a corollary, where a series of annotations 64 each have the same associated action, a single edit to the action function 82 or its action parameters 84 modifies that action with respect to all of its linked annotations 64.

The indicator 126 is understood not to be a part of the content of the document 54, and is merely an interactive component that is displayed on the workspace window 50. Accordingly, when the document 54 is printed as a hard copy, it does not appear thereon. Furthermore, to ensure interoperability with other PDF reviewing applications that may not necessarily recognize the action identifier and its associated functionality, when the PDF document is flattened, that is, the aggregating each of the annotations placed on the document 54 and making it part of the content, such action identifiers are replaced with conventional hyperlinks.

The various annotations accessible from the toolbox window 56 are stored in a persistent memory associated therewith so that they may be reused even when the document 54 in which such an annotation is placed, is closed. According to one contemplated embodiment, the retention procedures differ depending on whether the associated action function 82 is document-specific or document-independent.

Where the action identifier 78 specifies an action function 82 that is dependent on the currently opened document 54, for example, jumping to a particular region thereof, the corresponding action parameters 84 are not retained as no longer being valid. When the document 54 is closed and a different document is opened, upon instantiating a new annotation from the thumbnail representation 76, the action edit window 94 is opened and a new set of action parameters 84 are requested.

On the other hand, where the action identifier 78 specifies an action function 82 that is independent of the currently opened document 54, the corresponding action parameters 84 are retained because they remain valid regardless of what document 54 is currently open. For example, a URI specifying an external resource is the same whether it is referenced from one document 54 or another. After closing the document 54 and opening another document, the same URI can be linked from the recently opened document. Accordingly, no further intervention is necessary.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method for tracking annotations on a document, comprising:
receiving a first annotation defined by a plurality of first annotation attributes;
generating in a workspace window a primary visual representation of the first annotation according to the first annotation attributes, the first annotation being overlaid on the document;
associating an action identifier with the first annotation as an action link, the action identifier including an action function selected by a user and a set of action parameters; and
generating a thumbnail representation of the first annotation in a toolbox window, a second annotation defined by a plurality of second annotation attributes and associated with the action identifier derived from the action link for the first annotation being linkable to the document in response to a selection input of the thumbnail representation of the first annotation.

2. The method of claim 1, further comprising:
generating in the workspace window a primary visual representation of the second annotation according to the second annotation attributes in response to the selection input of the thumbnail representation of the first annotation in the toolbox window, the second annotation being overlaid on the document.

3. The method of claim 1, further comprising:
storing the action link in the document.

4. The method of claim 1, wherein the second annotation attributes are derived at least in part from the first annotation attributes.

5. The method of claim 1, further comprising:
generating on the workspace window an indicator in close proximity to the primary visual representation of the first annotation;
wherein the action function associated with the first annotation is triggered with the corresponding set of action parameters.

6. The method of claim 1, wherein the action function selected by the user has a document destination associated therewith that is part of the set of action parameters.

7. The method of claim 6, wherein the document destination of the action function is specific to the document.

8. The method of claim 7, wherein the action function includes loading a page of the document as designated by the corresponding set of action parameters.

9. The method of claim 7, wherein the action function includes loading a snapshot segment of the document as designated by the corresponding set of action parameters.

10. The method of claim 6, wherein the document destination of the action function is independent of the document.

11. The method of claim 10, wherein the action function includes loading a page of a different document as designated by the corresponding set of action parameters.

12. The method of claim 10, wherein the action function includes loading a hyperlinked document as designated by a one of the corresponding set of action parameters.

13. The method of claim 10, wherein the action function includes invoking a different application to open a different document as designated by the corresponding set of action parameters.

14. The method of claim 1, wherein the action function selected by the user is printing the document.

15. A method for tracking annotations on a document, comprising:
linking to the document a first annotation defined by a plurality of first annotation attributes;
associating an action identifier with the first annotation as a first element of an action link, the action identifier including an action function having a document destination and a set of action parameters;
generating a thumbnail representation of the first annotation in a toolbox window;
linking a second annotation to the document in response to a first input, the second annotation being defined by a plurality of second annotation attributes; and
associating the action identifier with the second annotation as a second element of the action link different from the first element of the action link.

16. The method of claim 15, wherein the first input is a selection of the thumbnail representation of the first annotation on the toolbox window.

17. The method of claim 15, wherein the second set of annotation attributes are derived at least in part from the first set of annotation attributes.

18. The method of claim 15, wherein prior to linking the first annotation to the document, the method further includes loading the document into a workspace window.

19. The method of claim 18, further comprising:
generating in the workspace window a primary visual representation of the first annotation according to the first annotation attributes, the first annotation being overlaid on the document.

20. The method of claim 18, further comprising:
generating in the workspace window a primary visual representation of the second annotation according to the second annotation attributes, the second annotation being overlaid on the document.

21. The method of claim 18, further comprising:
storing the first annotation and the action identifier in a persistent memory associated with the toolbox window; and
loading a different document into the workspace window.

22. The method of claim 21, wherein the action function is document-dependent and the method further includes:
removing pre-existing elements of the action link;
assigning different values to the set of action parameters;
linking a third annotation to the document in response to a second input, the third annotation being defined by a plurality of second annotation attributes; and
associating the action identifier with the third annotation as one element of the action link.

23. The method of claim 21, wherein the action function is document-independent and the method further includes:
removing pre-existing elements of the action link;
linking a third annotation to the document in response to a second input, the third annotation being defined by a plurality of second annotation attributes; and
associating the action identifier with the third annotation as one element of the action link.

24. A computer readable medium having computer-executable instructions for performing a method for tracking annotations on a document, the method comprising:
receiving a first annotation defined by a plurality of first annotation attributes;
generating in a workspace window a primary visual representation of the first annotation according to the first annotation attributes, the first annotation being overlaid on the document;
associating an action identifier with the first annotation as an action link, the action identifier including an action function having a document destination and a set of action parameters; and
generating a thumbnail representation of the first annotation in a toolbox window, a second annotation defined by a plurality of second annotation attributes and associated with the action identifier derived from the action link for the first annotation being linkable to the document in response to a selection input of the thumbnail representation of the first annotation.
